(19) United States
(12) Patent Application Publication
(10) Pub. No.: US 2026/0029703 A1
(43) Pub. Date: Jan. 29, 2026

(54) LIGHTING SYSTEM AND PROJECTION DEVICE

(71) Applicant: Coretronic Corporation, Hsin-Chu (TW)

(72) Inventors: Yu-Hsiang DENG, Hsin-Chu (TW); Min-Chang CHANG, Hsin-Chu (TW)

(21) Appl. No.: 19/275,993

(22) Filed: Jul. 22, 2025

(30) Foreign Application Priority Data
Jul. 23, 2024 (CN) 2024109927492

(51) Int. Cl. G03B 21/20

(52) U.S. Cl. CPC G03B 21/208; G03B 21/2033; G03B 21/2066

(57) ABSTRACT

The present invention provides a lighting system that combines tri-color pure lasers and phosphors and a projection device thereof. The lighting system helps to improve the phenomenon of laser speckle and includes a laser light source module, a wavelength converter, a segmented dichroic mirror, and a light homogenizing component. The laser light source module is configured to provide blue, green, and red laser beams. The wavelength converter is configured to reflect the tri-color laser beams and convert the blue laser beam into an excitation beam. The segmented dichroic mirror is configured to reflect the tri-color laser beams and at least a portion of the excitation beam from the wavelength converter. The light homogenizing component is configured to receive and homogenize the tri-color laser beams and at least a portion of the excitation beam from the segmented dichroic mirror to provide an illumination beam.

### CROSS REFERENCE TO RELATED APPLICATION

This application claims the priority benefit of Chinese Patent Application Serial Number 2024109927492, filed on Jul. 23, 2024, the full disclosure of which is incorporated herein by reference.

### BACKGROUND

### 1. Technical Field

The present application relates to a lighting system and a projection device, particularly to a lighting system and a projection device that includes the lighting system.

### 2. Description of the Related Art

Existing laser projectors include various types of lighting systems. The light sources in these lighting systems can be divided into those that provide pure laser beams for illumination, those that use lasers to excite phosphors for lighting, or those that directly use light-emitting diodes (LEDs) as the light source. However, each of these methods has corresponding drawbacks. For example, using pure laser beams can result in speckle and brightness limitations due to the size of the packaging, making it challenging to provide an optimal light source effect.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The present invention provides a lighting system that helps to mitigate the drawbacks of laser speckle, thereby offering an improved lighting effect.

The present invention also provides a projection device that includes the aforementioned lighting system, which delivers excellent lighting performance.

Other objectives and advantages of the present invention can be further understood from the technical features disclosed in this invention.

To achieve one or some or all of the aforementioned objectives or other objectives, an embodiment of the present invention proposes a lighting system, which includes: a laser light source module configured to provide a blue laser beam, a green laser beam, and a red laser beam; a wavelength converter positioned in the transmission paths of the red laser beam, the green laser beam, and the blue laser beam, where the wavelength converter is used to reflect the red laser beam, the green laser beam, and the blue laser beam, and the wavelength converter is adapted to convert the blue laser beam to produce an excitation beam; a segmented dichroic mirror positioned in the transmission paths of the red laser beam, the green laser beam, the blue laser beam, and the excitation beam, and located between the laser light source module and the wavelength converter, where the segmented dichroic mirror is used to reflect the red laser beam, the green laser beam, the blue laser beam, and at least a portion of the excitation beam coming from the wavelength converter; a light homogenizing component positioned in the transmission paths of the red laser beam, the green laser beam, the blue laser beam, and at least a portion of the excitation beam, configured to receive and homogenize the red laser beam, the green laser beam, the blue laser beam, and at least a portion of the excitation beam from the segmented dichroic mirror to provide an illumination beam.

To achieve one or some or all of the aforementioned objectives or other objectives, an embodiment of the present invention proposes a projection device, which includes the previously described lighting system for providing an illumination beam; a light modulation system positioned in a transmission path of the illumination beam, used to convert the illumination beam into an image beam; and a projection lens positioned in a transmission path of the image beam, used to project the image beam out of the projection device.

Based on the above, embodiments of the present invention have at least one of the following advantages or effects. In the design of the lighting system of the present invention, the laser light source module provides tri-color laser beams. The tri-color laser beams first pass through the segmented dichroic mirror and directly illuminate the wavelength converter. The wavelength converter contains phosphors, and after the tri-color laser beams are reflected back by the wavelength converter to the segmented dichroic mirror, they are further reflected by the segmented dichroic mirror to the light homogenizing component to provide an illumination beam. This design improves the issue of laser speckle and provides excellent illumination. Furthermore, a projection device utilizing the lighting system of the present invention can achieve superior illumination and projection effects.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings presented herein serve to deepen the understanding of the present application and are an integral part thereof. The illustrative embodiments and their explanations are provided to elucidate the present application and do not impose any undue limitations on it. In the drawings:

FIG. 1 illustrates a block diagram of a projection device according to an embodiment of the present invention;

FIG. 2 illustrates a schematic diagram of a lighting system according to an embodiment of the present invention;

FIG. 3 illustrates a wavelength schematic diagram of the first area of a segmented dichroic mirror according to an embodiment of the present invention;

FIG. 4 illustrates a wavelength schematic diagram of the second area of a segmented dichroic mirror according to an embodiment of the present invention;

FIG. 5 illustrates a schematic diagram of a wavelength converter according to an embodiment of the present invention;

FIG. 6 illustrates a schematic diagram of a wavelength converter according to another embodiment of the present invention;

FIG. 7 illustrates a front projection view of a wavelength converter according to an embodiment of the present invention;

FIG. 8 illustrates a front projection view of a wavelength converter according to another embodiment of the present invention;

FIG. 9 illustrates a schematic diagram of the laser light source module providing beams in various time sequences according to an embodiment of the present invention;

FIG. 10 illustrates a schematic diagram of the light path during the first time sequence of a lighting system according to an embodiment of the present invention;

FIG. 11 illustrates a schematic diagram of the light path during the second time sequence of a lighting system according to an embodiment of the present invention;

FIG. 12 illustrates a schematic diagram of the light path during the third time sequence of a lighting system according to an embodiment of the present invention;

FIG. 13 illustrates a schematic diagram of the light path of the blue laser beam during the fourth time sequence of a lighting system according to an embodiment of the present invention;

FIG. 14 illustrates a schematic diagram of the light path of the green laser beam during the fourth time sequence of a lighting system according to an embodiment of the present invention;

FIG. 15 illustrates a schematic diagram of the light path of the red laser beam during the fourth time sequence of a lighting system according to an embodiment of the present invention;

FIG. 16 illustrates a schematic diagram of the arrangement of laser emitters in the laser light source module according to an embodiment of the present invention;

FIG. 17 illustrates a schematic diagram of the arrangement of laser emitters in the laser light source module according to another embodiment of the present invention;

FIG. 18 illustrates a schematic diagram of a lighting system according to an embodiment of the present invention;

FIG. 19A illustrates a schematic diagram of a lighting system according to another embodiment of the present invention;

FIG. 19B illustrates a schematic diagram of a lighting system according to another embodiment of the present invention;

FIG. 20 illustrates a schematic diagram of a lighting system according to an embodiment of the present invention;

FIG. 21 illustrates a wavelength schematic diagram of the first area of the segmented dichroic mirror of FIG. 20;

FIG. 22 illustrates a schematic diagram of the light path of the blue laser beam in a lighting system according to an embodiment of the present invention;

FIG. 23 illustrates a wavelength schematic diagram of the splitter of FIG. 22; and

FIG. 24 illustrates a schematic diagram of the light path of the green laser beam in a lighting system according to FIG. 22.

### DETAILED DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

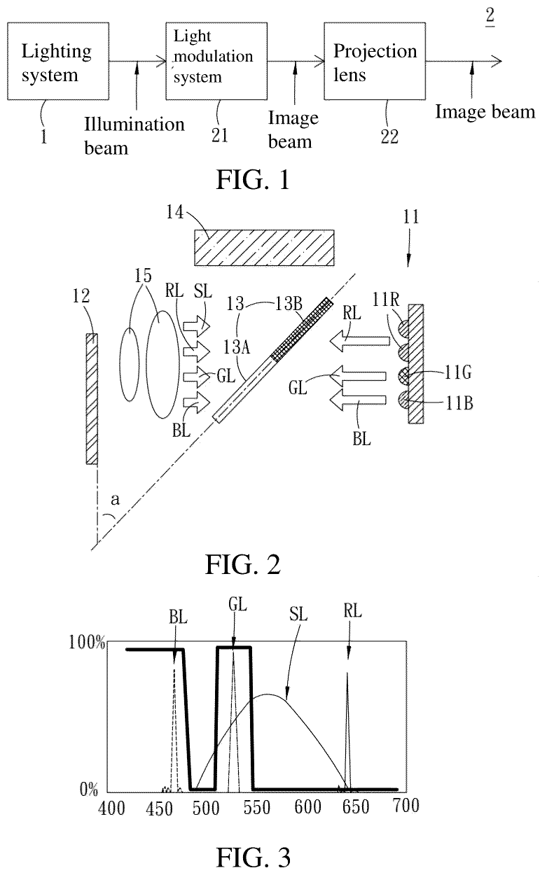

Please refer to FIG. 1 and FIG. 2. FIG. 1 illustrates a block diagram of a projection device according to an embodiment of the present invention, and FIG. 2 illustrates a schematic diagram of a lighting system. As shown in the figures, present embodiment provides a lighting system 1, which includes a laser light source module 11, a wavelength converter 12, a segmented dichroic mirror 13, and a light homogenizing component 14. The laser light source module 11 is configured to provide a blue laser beam BL, a green laser beam GL, and a red laser beam RL. The wavelength converter 12 is positioned in the transmission path of the red laser beam RL, the green laser beam GL, and the blue laser beam BL. The wavelength converter 12 is used to reflect the red laser beam RL, the green laser beam GL, and the blue laser beam BL, and is also adapted to convert the blue laser beam BL to generate an excitation beam SL. The segmented dichroic mirror 13 is located in the transmission path of the red laser beam RL, the green laser beam GL, the blue laser beam BL, and the excitation beam SL, and is positioned between the laser light source module 11 and the wavelength converter 12. The segmented dichroic mirror 13 is used to reflect the red laser beam RL, the green laser beam GL, the blue laser beam BL, and at least a portion of the excitation beam SL from the wavelength converter 12. The light homogenizing component 14 is positioned in the transmission path of the red laser beam RL, the green laser beam GL, the blue laser beam BL, and at least a portion of the excitation beam SL, and is used to receive and homogenize the red laser beam RL, the green laser beam GL, the blue laser beam BL, and at least a portion of the excitation beam SL from the segmented dichroic mirror 13, to provide an illumination beam.

The laser light source module 11 includes at least one red laser emitter 11R for providing a red laser beam RL, at least one green laser emitter 11G for providing a green laser beam GL, and at least one blue laser emitter 11B for providing a blue laser beam BL. The red laser emitter 11R, the green laser emitter 11G, and the blue laser emitter 11B may be, for example, laser diodes (LD). When multiple laser diodes are used, they may be arranged in a matrix. In this embodiment, the central wavelength of the red laser beam RL is above 635 nm, the central wavelength of the green laser beam GL is between 515 nm and 530 nm, and the central wavelength of the blue laser beam BL is below 465 nm. Since the laser emitters provide narrow wavelength beams, in present embodiment, the combination of the red laser beam RL, the green laser beam GL, the blue laser beam BL, and the excitation beam SL supplements the missing wavelength ranges among the three primary colors in the red laser beam RL, the green laser beam GL, or the blue laser beam BL, thereby improving the issue of laser speckle. This results in providing an excellent illumination light source.

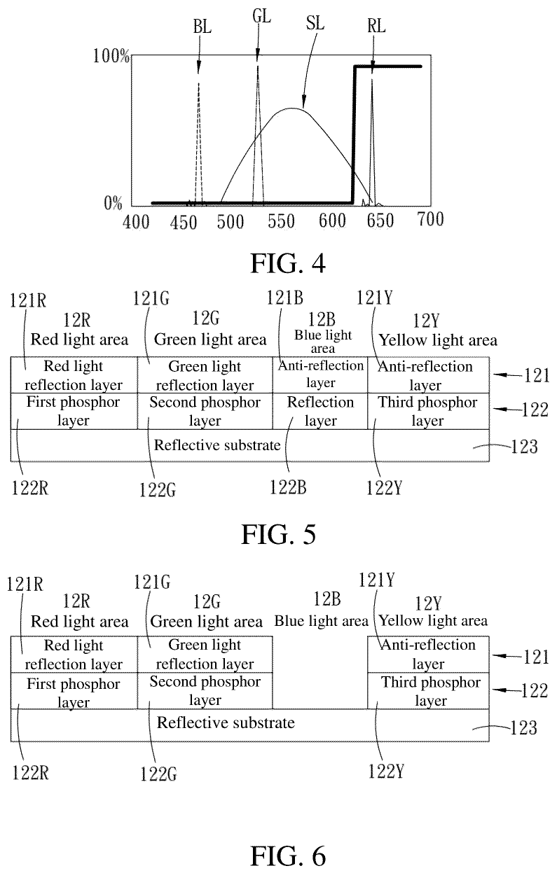

Please refer to FIG. 2, FIG. 3, and FIG. 4 together. FIG. 3 illustrates a wavelength diagram of the first area of the segmented dichroic mirror according to an embodiment of the present invention, and FIG. 4 illustrates a wavelength diagram of the second area of the segmented dichroic mirror. As shown in FIG. 2, in present embodiment, the segmented dichroic mirror 13 includes a first area 13A and a second area 13B. The first area 13A is adjacent to the second area 13B. The first area 13A is located in the transmission path of the green laser beam GL and blue laser beam BL from the laser light source module 11 and is not in the transmission path of the red laser beam RL from the laser light source module 11. The first area 13A allows the green laser beam GL and blue laser beam BL from the laser light source module 11 to pass through while reflecting the red laser beam RL and at least a portion of the excitation beam SL from the wavelength converter 12. The second area 13B is located in the transmission path of the red laser beam RL from the laser light source module 11 and is not in the transmission path of the green laser beam GL and blue laser beam BL from the laser light source module 11. The second area 13B allows the red laser beam RL from the laser light source module 11 to pass through while reflecting the green laser beam GL, the blue laser beam BL, and at least a portion of the excitation beam SL from the wavelength converter 11.

As described above, as shown in FIG. 3, the first area 13A is a band-pass filter, with a transmission wavelength range between 400 nm to 480 nm and 510 nm to 540 nm. As shown in FIG. 4, the second area 13B is a high-pass filter, with a transmission wavelength range between 610 nm to 660 nm. In present embodiment, when the red laser beam RL from the laser light source module 11 passes through the second area 13B, at least a portion of the wavelength range of the red laser beam RL needs to fall within the 610 nm to 660 nm range. When the green laser beam GL and the blue laser beam BL from the laser light source module 11 pass through the first area 13A, at least a portion of the wavelength range of the green laser beam GL needs to fall within the 510 nm to 540 nm range, and at least a portion of the wavelength range of the blue laser beam BL needs to fall within the 400 nm to 480 nm range. In other words, the wavelength range of the red laser beam RL overlaps at least partially with the transmission wavelength range of the second area 13B, and the wavelength ranges of the green laser beam GL and blue laser beam BL each overlap at least partially with the transmission wavelength range of the first area 13A. Furthermore, the excitation beam SL generated by the wavelength converter 12 has a broader wavelength range, so when the excitation beam SL enters the first area 13A and the second area 13B of the segmented dichroic mirror 13, some wavelengths of the excitation beam SL may pass through the segmented dichroic mirror 13, but a portion of the excitation beam SL will still be reflected by the segmented dichroic mirror 13 and directed to the light homogenizing component 14. Additionally, the segmented dichroic mirror 13 is inclined relative to the incident light surface of the wavelength converter 12. In one embodiment, the angle α between the segmented dichroic mirror 13 and the incident light surface of the wavelength converter 12 is 45 degrees, but this is not limiting.

In present embodiment, the lighting system 1 further includes a lens assembly 15, which is positioned between the wavelength converter 12 and the segmented dichroic mirror 13. The lens assembly 15 is configured to focus the red laser beam RL, the green laser beam GL, and the blue laser beam BL from the segmented dichroic mirror 13 onto the wavelength converter 12.

Please refer to FIG. 5 and FIG. 6. FIG. 5 illustrates schematic diagram of a wavelength converter according to an embodiment of the present invention, and FIG. 6 illustrates a schematic diagram of a wavelength converter according to another embodiment of the present invention. As shown in FIG. 5 and FIG. 6, the wavelength converter 12 includes a first layer 121, a second layer 122, and a reflective substrate 123, stacked sequentially, with the first layer 121 facing the segmented dichroic mirror 13. The wavelength converter 12 includes a red light area 12R, a green light area 12G, and a blue light area 12B. The red light area 12R, the green light area 12G, and the blue light area 12B are designed to enter the light transmission path at different times. The first layer 121 corresponding to the red light area 12R is a red light reflection layer 121R, and the second layer 122 corresponding to the red light area 12R is a first phosphor layer 122R. The first layer 121 corresponding to the green light area 12G is a green light reflection layer 121G, and the second layer 122 corresponding to the green light area 12G is a second phosphor layer 122G. Please refer again to FIG. 5. In present embodiment, the first layer 121 of the blue light area 12B is an anti-reflection layer 121B, and the second layer 122 of the blue light area 12B is a reflection layer 122B or a blue light reflection layer. In other embodiments, the blue light area 12B may not have the structure of the first layer 121. Please refer again to FIG. 6. In another embodiment, the blue light area 12B may have neither the structure of the first layer nor the second layer, and any laser beam incident on the blue light area 12B will be reflected by the reflective substrate 123. In one embodiment, the wavelength range reflected by the red light reflection layer 121R is the same as the transmission wavelength range of the second area 13B of the segmented dichroic mirror 13 (for example, between 610 nm and 660 nm), while the wavelength range reflected by the green light reflection layer 121G is the same as the transmission wavelength range corresponding to green light in the first area 13A of the segmented dichroic mirror 13 (for example, between 510 nm and 540 nm).

In present embodiment, the first phosphor layer 122R and the second phosphor layer 122G are both composed of phosphor materials designed to convert the excitation beam SL into yellow light. The wavelength range covered by the excitation beam SL generated by the phosphor conversion is relatively broad. The excitation beam SL can be used to supplement the narrow wavelength ranges of the red laser beam RL, the green laser beam GL, or the blue laser beam BL, thereby enhancing the color light output of the red laser beam RL, the green laser beam GL, and the blue laser beam BL. The color of the phosphor material in the aforementioned phosphor layers can be adjusted according to user requirements. That is, the phosphor materials in the first phosphor layer 122R and the second phosphor layer 122G may be of the same color or different colors. In one embodiment, the first phosphor layer 122R may be composed of phosphor material that converts the excitation beam into red or orange light, while the second phosphor layer 122G may be composed of phosphor material that converts the excitation beam into green light. However, this is not limited to these specific examples.

In one embodiment, the wavelength converter 12 further includes a yellow light area 12Y. The red light area 12R, the green light area 12G, the blue light area 12B, and the yellow light area 12Y are configured to enter the light transmission path at different timing sequences. The first layer 121 corresponding to the yellow light area 12Y is an anti-reflection layer 121Y, and the second layer 122 corresponding to the yellow light area 12Y is a third phosphor layer 122Y. The third phosphor layer 122Y is composed of phosphor material that converts the excitation beam into yellow light. The yellow light area 12Y is set up for the purpose of light supplementation, enabling the lighting system 1 to provide an improved illumination beam.

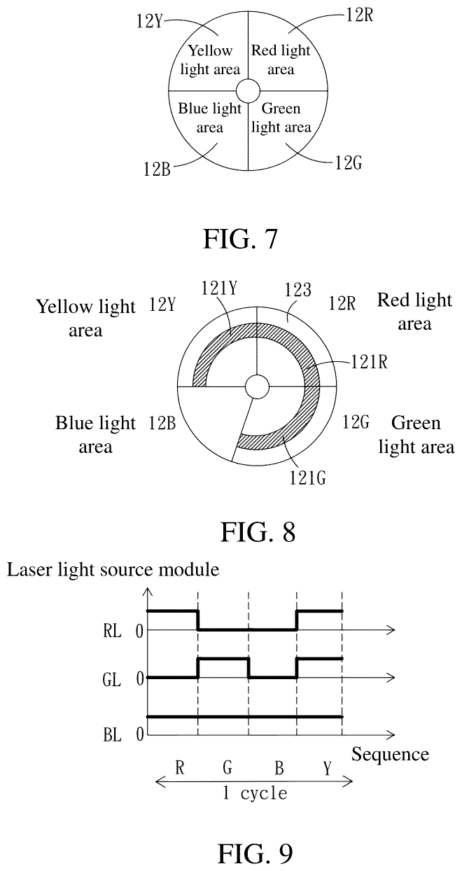

Please refer to FIG. 7 and FIG. 8 together. FIG. 7 illustrates a front elevation view of the wavelength converter 12 according to one embodiment of the present invention, and FIG. 8 illustrates a front elevation view of the wavelength converter 12 according to another embodiment. As shown in FIG. 7, in one embodiment, the red light area 12R, the green light area 12G, the blue light area 12B, and the yellow light area 12Y of the wavelength converter 12 may be equally divided, with each area occupying one-fourth of the total area. As shown in FIG. 8, in another embodiment, the proportion of the red light area 12R, the green light area 12G, the blue light area 12B, and the yellow light area 12Y in the wavelength converter 12 can be adjusted according to the user's requirements. For example, the red light area 12R may occupy 25% of the total area, the green light area 12G may occupy 30%, the blue light area 12B may occupy 20%, and the yellow light area 12Y may occupy 25%. This configuration allows for different lighting variations. In one embodiment, the first layer 121 and the second layer 122 of the wavelength converter 12 form a C-shaped structure, meaning that the blue light area 12B does not have any stacked layer structure. The light beams entering the blue light area 12B are primarily reflected by the reflective substrate 123 (as shown in FIG. 6). Additionally, as shown in the stacked structure of FIG. 5, a front elevation view of an embodiment may exhibit a ring-shaped structure, where the blue light area 12B presents a stacked structure of the anti-reflection layer 121B and the reflection layer 122B, filling the original C-shaped structure into a ring shape. Furthermore, the size of the first layer 121 and the second layer 122 corresponding to each area can be the same or different. For example, when the size of the first layer 121 and the second layer 122 in the same area are identical, their projections will completely overlap. When the size of the first layer 121 and the second layer 122 in the same area are different (as shown in FIG. 8), i.e., the size of the first layer 121 is smaller than the second layer 122, the projection of the first layer 121 will completely overlap with a part of the projection of the second layer 122.

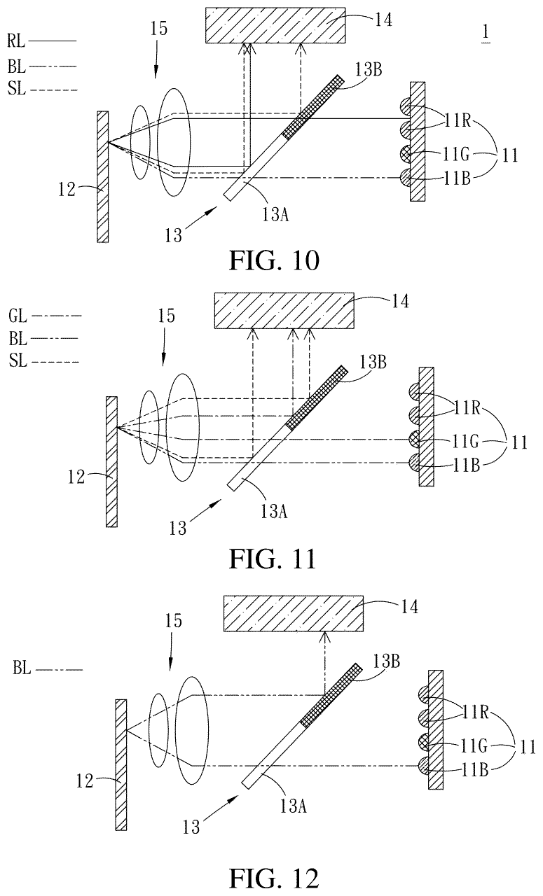

Please refer to FIG. 9 and FIG. 10 together. FIG. 9 illustrates a schematic diagram showing the light beams provided by the laser light source module in various sequences according to one embodiment of the present invention, and FIG. 10 illustrates a schematic diagram of the light path in the first sequence of the lighting system according to one embodiment of the present invention. In the first sequence (i.e., the red light sequence R), the blue laser emitter 11B and the red laser emitter 11R of the laser light source module 11 are turned on to provide a blue laser beam BL (represented by the dashed line in the figures) and a red laser beam RL (represented by the solid line in the figures), respectively. At this time, the laser light source module 11 does not provide the green laser beam GL, and the red light area 12R of the wavelength converter 12 enters the light transmission path. The blue laser beam BL from the laser light source module 11 passes through the first area 13A of the segmented dichroic mirror 13 and is incident on the red light area 12R of the wavelength converter 12. The blue laser beam BL penetrates the red light reflection layer 121R of the first layer 121 and generates an excitation beam SL (represented by the dotted line in the figures) in the first phosphor layer 122R of the second layer 122. The excitation beam SL is reflected by the reflective substrate 123 back to the red light reflection layer 121R of the first layer 121. A first portion of the excitation beam SL will penetrate the red light reflection layer 121R and be transmitted to the segmented dichroic mirror 13, and then to the light homogenizing component 14, to provide an illumination beam. Specifically, when the excitation beam SL is reflected by the reflective substrate 123 back to the red light reflection layer 121R of the first layer 121, a portion of the excitation beam SL will be blocked and reflected by the red light reflection layer 121R. That is, if the wavelength range of the excitation beam SL falls within the reflective wavelength range of the red light reflection layer 121R (for example, between 610 nm and 660 nm), it will be blocked by the red light reflection layer 121R and will not penetrate through. Another portion of the excitation beam SL, whose wavelength range does not fall within the reflective wavelength range of the red light reflection layer 121R, can penetrate the red light reflection layer 121R. In other words, the portion of the excitation beam SL that penetrates the red light reflection layer 121R is the first portion of the excitation beam SL. At the same time, the red laser beam RL from the laser light source module 11 passes through the second area 13B of the segmented dichroic mirror 13 and is incident on the red light area 12R of the wavelength converter 12. The red laser beam RL is reflected by the red light reflection layer 121R of the first layer 121 and is transmitted to the first area 13A of the segmented dichroic mirror 13, and then to the light homogenizing component 14, to provide an illumination beam.

As described above, the excitation beam SL is excited by the phosphor and has a relatively wide beam width. Therefore, the first portion of the excitation beam SL that penetrates the red light reflection layer 121R can simultaneously cover both the first area 13A and the second area 13B of the segmented dichroic mirror 13. The majority of the first portion of the excitation beam SL can be reflected by the first area 13A and the second area 13B of the segmented dichroic mirror 13. For the first area 13A of the segmented dichroic mirror 13, among the first portion of the excitation beam SL entering the first area 13A, those with a wavelength range falling within the transmission wavelength range of the first area 13A (e.g., between 400 nm and 480 nm and between 510 nm and 540 nm) will penetrate through the first area 13A of the segmented dichroic mirror 13. The remaining portion will be reflected by the first area 13A and transmitted to the light homogenizing component 14. For the second area 13B of the segmented dichroic mirror 13, among the first portion of the excitation beam SL entering the second area 13B, those with a wavelength range falling within the transmission wavelength range of the second area 13B (e.g., between 610 nm and 660 nm) will penetrate through the second area 13B of the segmented dichroic mirror 13. The remaining portion will be reflected by the second area 13B. If the wavelength range reflected by the red light reflection layer 121R is the same as the transmission wavelength range of the second area 13B of the segmented dichroic mirror 13, then the entire first portion of the excitation beam SL entering the second area 13B will be reflected to the light homogenizing component 14.

Please refer to FIG. 11, which illustrates an optical path diagram of the lighting system during the second timing sequence according to one embodiment of the present invention. In the second timing sequence (i.e., the green light sequence G), the blue laser emitters 11B and the green laser emitters 11G of the laser light source module 11 are activated to provide the blue laser beam BL and the green laser beam GL, respectively (both indicated by dashed lines in the figure). At this time, the laser light source module 11 does not provide the red laser beam RL, and the green light area 12G of the wavelength converter 12 enters the optical transmission path. The blue laser beam BL and the green laser beam GL from the laser light source module 11 pass through the first area 13A of the segmented dichroic mirror 13 and are incident on the green light area 12G of the wavelength converter 12. The blue laser beam BL penetrates the green light reflection layer 121G of the first layer 121 and generates the excitation beam SL in the second phosphor layer 122G of the second layer 122. The excitation beam SL is reflected by the reflective substrate 123 back to the green light reflection layer 121G of the first layer 121, and a second portion of the excitation beam SL penetrates the green light reflection layer 121G and is transmitted to the segmented dichroic mirror 13, and then transmitted to the light homogenizing component 14 to provide the illumination beam. Specifically, when the excitation beam SL is reflected by the reflective substrate 123 back to the green light reflection layer 121G of the first layer 121, a portion of the excitation beam SL is blocked and reflected by the green light reflection layer 121G. That is, the portion of the excitation beam SL with a wavelength range that falls within the reflection wavelength range of the green light reflection layer 121G (e.g., between 510 nm and 540 nm) is blocked by the green light reflection layer 121G and cannot penetrate. Another portion of the excitation beam SL, which does not fall within the reflection wavelength range of the green light reflection layer 121G, can penetrate the green light reflection layer 121G. In other words, the portion of the excitation beam SL that penetrates the green light reflection layer 121G is the second portion of the excitation beam SL. Meanwhile, the green laser beam GL from the segmented dichroic mirror 13 is reflected by the green light reflection layer 121G of the first layer 121 and is transmitted to the second area 122 of the segmented dichroic mirror 12, and then transmitted to the light homogenizing component 14 to provide the illumination beam.

Additionally, the second portion of the excitation beam SL that penetrates the green light reflection layer 121G is directed towards the segmented dichroic mirror 13. The manner in which the segmented dichroic mirror 13 reflects this second portion of the excitation beam SL is similar to how it reflects the first portion of the excitation beam SL. Therefore, further details are not reiterated here.

Please refer to FIG. 12, which illustrates a light path diagram of the lighting system during a third timing sequence according to an embodiment of the present invention. In the third timing sequence (i.e., the blue light sequence B), the blue laser emitter 11B of the laser light source module 11 is activated to provide a blue laser beam BL. At this time, the laser light source module 11 does not provide the red laser beam RL or the green laser beam GL, and the blue light area 12B of the wavelength converter 12 enters the light transmission path. The blue laser beam BL from the laser light source module 11 passes through the first area 13A of the segmented dichroic mirror 13 and is incident on the blue light area 12B of the wavelength converter 12. The blue laser beam BL is then reflected by the blue light area 12B to the second area 13B of the segmented dichroic mirror 13 and subsequently transmitted to the light homogenizing component 14 to provide an illumination beam.

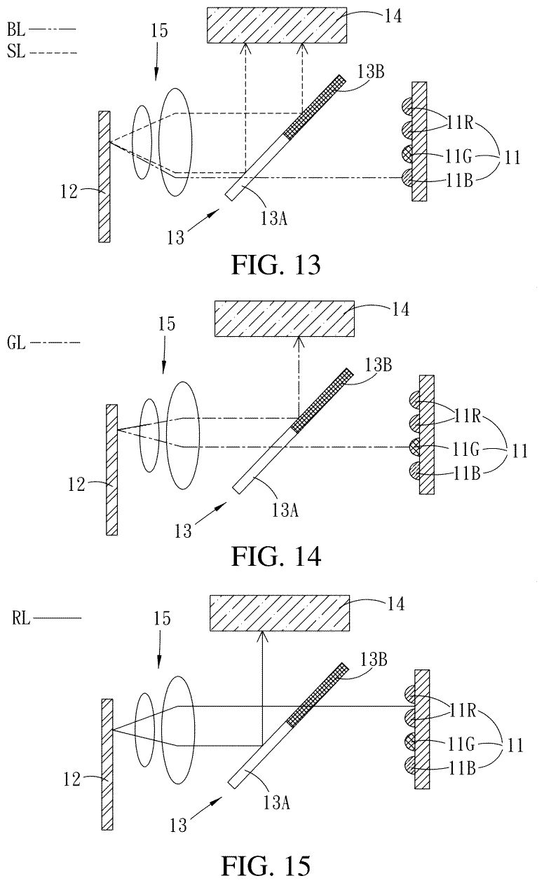

Please refer to FIG. 13, which illustrates a light path diagram of the blue laser beam during a fourth timing sequence of the lighting system according to an embodiment of the present invention. In the fourth timing sequence (i.e., the yellow light sequence Y), the blue laser emitter 11B of the laser light source module 11 is activated to provide a blue laser beam BL. At this time, the yellow light area 12Y of the wavelength converter 12 enters the light transmission path. The blue laser beam BL from the laser light source module 11 passes through the first area 13A of the segmented dichroic mirror 13 and is incident on the yellow light area 12Y of the wavelength converter 12. The blue laser beam BL penetrates the anti-reflection layer 121Y of the first layer 121 and generates an excitation beam SL in the third phosphor layer 122Y of the second layer 122. The excitation beam SL is then reflected by the reflective substrate 123 to the segmented dichroic mirror 13. As previously mentioned, the majority of the excitation beam SL entering the segmented dichroic mirror 13 can be reflected by the segmented dichroic mirror 13 and transmitted to the light homogenizing component 14 to provide an illumination beam. The present embodiment primarily allows for supplementary lighting to the red laser beam RL, the green laser beam GL, and the blue laser beam BL. The yellow light area 12Y can be configured according to actual needs and is not limited to the above description.

Please refer to FIGS. 14 and 15. FIG. 14 illustrates a light path diagram of the green laser beam during the fourth timing sequence of the lighting system according to an embodiment of the present invention, and FIG. 15 illustrates a light path diagram of the red laser beam during the fourth timing sequence of the lighting system according to an embodiment of the present invention. In the fourth timing sequence (i.e., the yellow light sequence Y), the laser light source module 11 may also provide at least one of the green laser beam GL and the red laser beam RL according to actual needs. As shown in FIG. 14, when the laser light source module 11 provides the green laser beam GL during the fourth timing sequence, the green laser beam GL passes through the first area 13A of the segmented dichroic mirror 13 and is incident on the yellow light area 12Y of the wavelength converter 12. The green laser beam GL penetrates the anti-reflection layer 121Y of the first layer 121 and the third phosphor layer 122Y of the second layer 122, and is reflected by the reflective substrate 123 back to the second area 13B of the segmented dichroic mirror 13. The green laser beam GL is then reflected by the second area 13B of the segmented dichroic mirror 13 to the light homogenizing component 14 to provide an illumination beam. As shown in FIG. 15, when the laser light source module 11 provides the red laser beam RL during the fourth timing sequence, the red laser beam RL passes through the second area 13B of the segmented dichroic mirror 13 and is incident on the yellow light area 12Y of the wavelength converter 12. The red laser beam RL penetrates the anti-reflection layer 121Y of the first layer 121 and the third phosphor layer 122Y of the second layer 122, and is reflected by the reflective substrate 123 back to the first area 13A of the segmented dichroic mirror 13. The red laser beam RL is then reflected by the first area 13A of the segmented dichroic mirror 13 to the light homogenizing component 14 to provide an illumination beam.

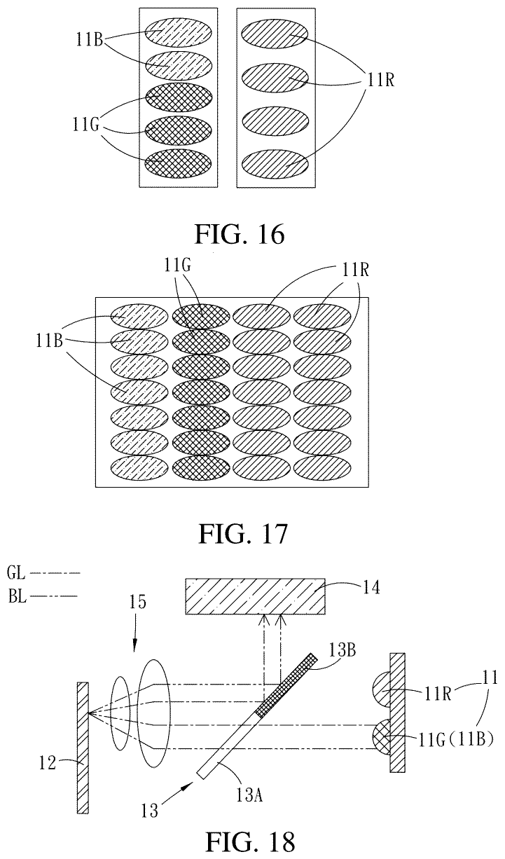

Please refer to FIGS. 16 and 17 together. FIG. 16 illustrates a schematic diagram of the arrangement of the laser emitters in the laser light source module according to an embodiment of the present invention, and FIG. 17 illustrates a schematic diagram of the arrangement of the laser emitters in the laser light source module according to another embodiment of the present invention. As shown in the figures, the laser light source module 11 includes a multiple of red laser emitters 11R that provide the red laser beam RL, a multiple of green laser emitters 11G that provide the green laser beam GL, and a multiple of blue laser emitters 11B that provide the blue laser beam BL. The arrangement of the laser emitters can be adjusted according to the user's needs. Taking FIG. 16 as an example, the multiple of red laser emitters 11R are arranged in a single row. The multiple of green laser emitters 11G and multiple of blue laser emitters 11B are arranged in another row adjacent to the multiple of red laser emitters 11R, with different proportions. In FIG. 17, the multiple of red laser emitters 11R are arranged in two rows, while the multiple of green laser emitters 11G and multiple of blue laser emitters 11B are each arranged in a single row, with all emitters arranged on the same substrate. The aforementioned embodiments adopt the arrangement of the laser light source module as shown in FIG. 17; however, the present invention does not limit the arrangement of the laser emitters, and it can be adjusted according to the user's needs.

Please refer to FIG. 18, which illustrates a schematic diagram of the lighting system according to an embodiment of the present invention. In FIG. 18, only the light paths of the green laser beam GL and the blue laser beam BL are illustrated, while the light paths of the red laser beam RL and the excitation beam SL are omitted. The present embodiment adopts the arrangement shown in FIG. 16, where the multiple of red laser emitters 11R, the multiple of green laser emitters 11G, and the multiple of blue laser emitters 11B are arranged together on the same substrate. In this manner, the green laser beam GL and the blue laser beam BL are directed toward the segmented dichroic mirror 13 from the same position and direction. This manufacturing method is relatively simple, but it is more restricted by the positions of the laser emitters in use.

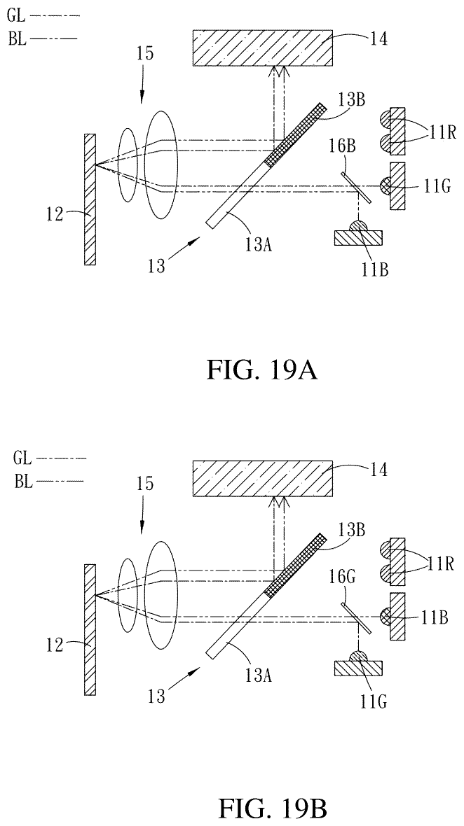

Please refer to FIG. 19A, which illustrates a schematic diagram of the lighting system according to another embodiment of the present invention. In FIG. 19A, only the light paths of the green laser beam GL and the blue laser beam BL are illustrated, while the light paths of the red laser beam RL and the excitation beam SL are omitted. As shown in the figure, the lighting system 1 further includes a blue light splitter 16B, which is located between the first area 13A of the segmented dichroic mirror 13 and the laser light source module 11. The laser light source module 11 comprises a multiple of red laser emitters 11R, a multiple of green laser emitters 11G, and a multiple of blue laser emitters 11B. The multiple of green laser emitters 11G and the multiple of blue laser emitters 11B are arranged on different planes, with the multiple of red laser emitters 11R adapted to provide the red laser beam RL, the multiple of blue laser emitters 11B adapted to provide the blue laser beam BL, and the multiple of green laser emitters 11G adapted to provide the green laser beam GL. The blue light splitter 16B is arranged in the light transmission path of the blue laser beam BL and the green laser beam GL. The blue light splitter 16B is used to reflect the blue laser beam BL while allowing the green laser beam GL to pass through, so that both the blue laser beam BL and the green laser beam GL enter the first area 13A of the segmented dichroic mirror 13 in the same direction. The present embodiment allows flexible modification of the internal structural design of the lighting system 1 by using the blue light splitter 16B in conjunction with the separately arranged multiple of red laser emitters 11R, the multiple of green laser emitters 11G, and the multiple of blue laser emitters 11B.

Please refer to FIG. 19B, which illustrates a schematic diagram of the lighting system according to another embodiment of the present invention. In FIG. 19B, only the light paths of the green laser beam GL and the blue laser beam BL are illustrated, while the light paths of the red laser beam RL and the excitation beam SL are omitted. The lighting system 1 further includes a green light splitter 16G, which is located between the first area 13A of the segmented dichroic mirror 13 and the laser light source module 11. The green light splitter 16G is used to reflect the green laser beam GL while allowing the blue laser beam BL to pass through, so that both the blue laser beam BL and the green laser beam GL enter the first area 13A of the segmented dichroic mirror 13 in the same direction. In the present embodiment, if the positions of the blue laser emitter 11B and the green laser emitter 11G in FIG. 19A are swapped, the original blue light splitter 16B needs to be replaced with the green light splitter 16G. The present embodiment allows for more combinations of light sources based on the user's needs by configuring the blue light splitter 16B and the green light splitter 16G.

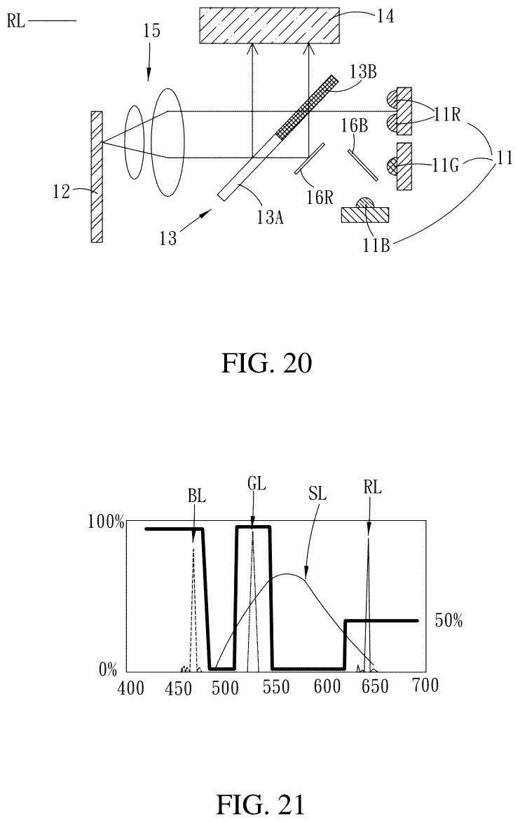

Please refer to FIGS. 20 and 21 together. FIG. 20 illustrates a schematic diagram of the lighting system according to an embodiment of the present invention, and FIG. 21 illustrates a wavelength schematic diagram of the first area of the segmented dichroic mirror in FIG. 20. In FIG. 20, only the light path of the red laser beam RL is illustrated, while the light paths of the green laser beam GL, the blue laser beam BL, and the excitation beam SL are omitted. Continuing with the structure shown in FIG. 19A, as illustrated in FIG. 20, the present embodiment further includes a red light splitter 16R, which allows the blue laser beam BL and the green laser beam GL to pass through while reflecting the red laser beam RL from the first area 13A of the segmented dichroic mirror 13. The red light splitter 16R is located between the first area 13A of the segmented dichroic mirror 13 and the laser light source module 11. The first area 13A of the segmented dichroic mirror 13 is used to reflect the first portion of the red laser beam RL from the wavelength converter 12 and allow the second portion of the red laser beam RL to pass through. The first portion of the red laser beam RL is reflected by the first area 13A of the segmented dichroic mirror 13 to the light homogenizing component 14 to provide illumination. The second portion of the red laser beam RL passes through the first area 13A of the segmented dichroic mirror 13 and is transmitted to the red light splitter 16R. The second portion of the red laser beam RL is then reflected by the red light splitter 16R and passes through the second area 13B of the segmented dichroic mirror 13 to the light homogenizing component 14 to provide illumination. The present embodiment allows for more combinations of light sources based on the user's needs by configuring the red light splitter 16R.

Referring to FIG. 21, as mentioned above, the first area 13A of the segmented dichroic mirror 13 in this embodiment allows the blue laser beam BL and the green laser beam GL to pass through while limiting the transmission of the red laser beam RL to 50% of its light intensity. In this embodiment, the first area 13A reflects the first portion of the red laser beam RL from the wavelength converter 12 (containing 50% of the light intensity), and the second portion of the red laser beam RL passes through (containing the remaining 50% of the light intensity). The first portion of the red laser beam RL is directly transmitted towards the light homogenizing component 14, while the second portion of the red laser beam RL is reflected by the red light splitter 16R. The present embodiment allows for more combinations of light sources based on the user's needs by adjusting the amount of light allowed to pass through different areas of the segmented dichroic mirror 13 (not limited to 50%).

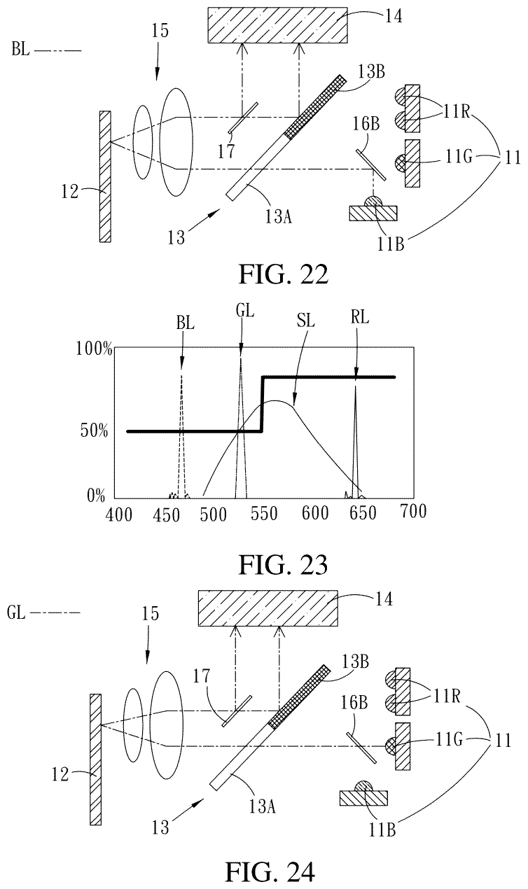

Referring to FIGS. 22 and 23, FIG. 22 illustrates the light path of the blue laser beam BL in the lighting system according to an embodiment of the present invention, and FIG. 23 illustrates the wavelength characteristics of the splitter 17 shown in FIG. 22. As depicted in FIG. 22, the present embodiment further includes a splitter 17, which is positioned between the second area 13B of the segmented dichroic mirror 13 and the wavelength converter 12. The splitter 17 is configured to reflect a first portion of the blue laser beam BL from the wavelength converter 12 and allow a second portion of the blue laser beam BL to pass through. The first portion of the blue laser beam BL is reflected by the splitter 17 towards the light homogenizing component 14, while the second portion of the blue laser beam BL passes through the splitter 17 to the second area 13B of the segmented dichroic mirror 13, where it is then reflected by the second area 13B towards the light homogenizing component 14. The present embodiment allows for more combinations of light sources based on the user's needs by configuring the splitter 17.

Referring to FIG. 23, in this embodiment, the splitter 17 is capable of limiting the amount of light passing through for both the blue laser beam BL and the green laser beam GL to 50%. In this embodiment, the splitter 17 reflects the first portion of the blue laser beam BL from the wavelength converter 12 (containing 50% of the light), while allowing the second portion (containing the remaining 50% of the light) to pass through. The first portion of the blue laser beam BL is directly transmitted towards the light homogenizing component 14, and the second portion is reflected by the second area 13B of the segmented dichroic mirror 13 towards the light homogenizing component 14. The present embodiment allows for the adjustment of the light passing through the splitter 17 (not limited to 50%) for both the blue laser beam BL and the green laser beam GL, providing additional flexibility in the combination of light sources based on user requirements.

Referring to FIG. 23 and FIG. 24, FIG. 24 illustrates the optical path of the green laser beam GL in the lighting system shown in FIG. 22. As depicted, the splitter 17 is further configured to reflect the first portion of the green laser beam GL from the wavelength converter 12 and allow the second portion of the green laser beam GL to pass through. The first portion of the green laser beam GL is reflected by the splitter 17 towards the light homogenizing component 14, while the second portion of the green laser beam GL passes through the splitter 17 to the second area 13B of the segmented dichroic mirror 13. The second portion of the green laser beam GL is then reflected by the second area 13B of the segmented dichroic mirror 13 towards the light homogenizing component 14. In the present embodiment, the splitter 17 reflects the first portion of the green laser beam GL from the wavelength converter 12 (containing 50% of the light), while the second portion of the green laser beam GL passes through (containing the remaining 50% of the light). The first portion of the green laser beam GL is directly transmitted towards the light homogenizing component 14, and the second portion of the green laser beam GL is reflected by the second area 13B of the segmented dichroic mirror 13 towards the light homogenizing component 14.

Referring again to FIG. 1, the present embodiment further provides a projection device 2, which includes the aforementioned lighting system 1, a light modulation system 21, and a projection lens 22. The lighting system 1 is used to provide an illumination beam. The light modulation system 21 is located in the path of the illumination beam and is configured to convert the illumination beam into an image beam. The projection lens 22 is located in the path of the image beam and is used to project the image beam out of the projection device 2. The present embodiment, by utilizing various embodiments of the lighting system 1, offers users a projection device 2 with diverse operational possibilities.

The light modulation system 21 includes a light modulation element, such as a digital micro mirror device (DMD), a liquid crystal on silicon (LCOS) panel, or other suitable spatial light modulators (SLMs). In some embodiments, the light modulation system 21 may also be a transmissive liquid crystal panel, but the invention is not limited to this. The projection lens 22 may comprise one or more optical lenses, with the refractive indices of the optical lenses being either the same or different from each other. For example, the optical lenses may include various non-planar lenses such as biconcave lenses, biconvex lenses, concave-convex lenses, convex-concave lenses, plano-convex lenses, and plano-concave lenses, or any combination thereof. On the other hand, the projection lens 22 may also include planar optical lenses. This application does not impose specific limitations on the detailed structure of the projection lens 22.

In summary, the embodiments of the present invention offer at least one of the following advantages or benefits. In the design of the lighting system, the laser light source module provides tri-color laser beams. These tri-color laser beams first pass through the segmented dichroic mirror and directly illuminate the wavelength converter, which contains phosphor. The tri-color laser beams are then reflected by the wavelength converter back to the segmented dichroic mirror, and subsequently reflected by the segmented dichroic mirror to the light homogenizing component to provide an illumination beam. This design helps mitigate the issue of laser speckle and provides an improved lighting effect. Additionally, when the projection device is equipped with the lighting system of the present invention, it can achieve excellent illumination and projection performance.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present invention is intended to be dedicated to the public regardless of whether the element or component is explicitly recited in the following claims.

What is claimed is:

1. A lighting system, comprising:
a laser light source module configured to provide a blue laser beam, a green laser beam, and a red laser beam;
a wavelength converter positioned in the transmission paths of the red laser beam, the green laser beam, and the blue laser beam, wherein the wavelength converter is configured to reflect the red laser beam, the green laser beam, and the blue laser beam, and to convert the blue laser beam to produce an excitation beam;
a segmented dichroic mirror positioned in the transmission paths of the red laser beam, the green laser beam, the blue laser beam, and the excitation beam, and located between the laser light source module and the wavelength converter, wherein the segmented dichroic mirror is configured to reflect the red laser beam, the green laser beam, the blue laser beam, and at least a portion of the excitation beam from the wavelength converter; and
a light homogenizing component positioned in the transmission paths of the red laser beam, the green laser beam, the blue laser beam, and at least a portion of the excitation beam, configured to receive and homogenize the red laser beam, the green laser beam, the blue laser beam, and at least a portion of the excitation beam from the segmented dichroic mirror to provide an illumination beam.

2. The lighting system as claimed in claim 1, wherein the segmented dichroic mirror comprises a first area and a second area, the first area being adjacent to the second area; the first area is positioned in the transmission paths of the green laser beam and the blue laser beam from the laser light source module, and is configured to allow the green laser beam and the blue laser beam from the laser light source module to pass through, while reflecting the red laser beam and at least a portion of the excitation beam from the wavelength converter; the second area is positioned in the transmission path of the red laser beam from the laser light source module, and is configured to allow the red laser beam from the laser light source module to pass through, while reflecting the green laser beam, the blue laser beam, and at least a portion of the excitation beam from the wavelength converter.

3. The lighting system as claimed in claim 2, wherein the first area is a band-pass filter, with a transmission wavelength range between 400 nm and 480 nm and between 510 nm and 540 nm, and the second area is a high-pass filter, with a transmission wavelength range between 610 nm and 660 nm.

4. The lighting system as claimed in claim 1, further comprising a lens assembly, wherein the lens assembly is positioned between the wavelength converter and the segmented dichroic mirror.

5. The lighting system as claimed in claim 2, wherein the wavelength converter comprises a first layer, a second layer, and a reflective substrate stacked sequentially, with the first layer positioned facing the segmented dichroic mirror.

6. The lighting system as claimed in claim 5, wherein the wavelength converter comprises a red light area, a green light area, and a blue light area, the red light area, the green light area, and the blue light area are configured to enter the light transmission path at different timing sequences; wherein the first layer corresponding to the red light area is a red light reflection layer, the second layer corresponding to the red light area is a first phosphor layer, the first layer corresponding to the green light area is a green light reflection layer, and the second layer corresponding to the green light area is a second phosphor layer.

7. The lighting system as claimed in claim 6, wherein both the first phosphor layer and the second phosphor layer are phosphors configured to convert the excitation beam into yellow light.

8. The lighting system as claimed in claim 6, wherein the first layer in the blue light area is an anti-reflection layer, and the second layer in the blue light area is a reflection layer.

9. The lighting system as claimed in claim 6, wherein during a first timing sequence, the laser light source module provides the blue laser beam and the red laser beam but does not provide the green laser beam, and the red light area of the wavelength converter enters the light transmission path, wherein:
the blue laser beam passes through the first area of the segmented dichroic mirror and enters the red light area, penetrating the red light reflection layer of the first layer and generating the excitation beam in the first phosphor layer of the second layer; wherein the excitation beam is reflected back to the red light reflection layer of the first layer by the reflective substrate, wherein a first portion of the excitation beam penetrates the red light reflection layer and is transmitted to the segmented dichroic mirror, then to the light homogenizing component;
the red laser beam passes through the second area of the segmented dichroic mirror and enters the red light area, wherein the red laser beam is reflected by the red light reflection layer of the first layer and transmitted to the first area of the segmented dichroic mirror, and then to the light homogenizing component.

10. The lighting system as claimed in claim 6, wherein during a second timing sequence, the laser light source module provides the blue laser beam and the green laser beam but does not provide the red laser beam, and the green light area of the wavelength converter enters the light transmission path; the blue laser beam and the green laser beam pass through the first area of the segmented dichroic mirror and enter the green light area, wherein:
the blue laser beam penetrates the green light reflection layer of the first layer and generates the excitation beam in the second phosphor layer of the second layer; the excitation beam is reflected back to the green light reflection layer of the first layer by the reflective substrate, wherein a second portion of the excitation beam penetrates the green light reflection layer and is transmitted to the segmented dichroic mirror, then to the light homogenizing component;
the green laser beam is reflected by the green light reflection layer of the first layer and transmitted to the second area of the segmented dichroic mirror, and then to the light homogenizing component.

11. The lighting system as claimed in claim 6, wherein during a third timing sequence, the laser light source module provides the blue laser beam but does not provide the red laser beam or the green laser beam, and the blue light area of the wavelength converter enters the light transmission path; the blue laser beam passes through the first area of the segmented dichroic mirror and enters the blue light area, wherein the blue laser beam is reflected by the blue light area to the second area of the segmented dichroic mirror, and then transmitted to the light homogenizing component.

12. The lighting system as claimed in claim 6, wherein the wavelength converter further includes a yellow light area; the red light area, the green light area, the blue light area, and the yellow light area are configured to enter the light transmission path at different timing sequences; wherein the first layer corresponding to the yellow light area is an anti-reflection layer, and the second layer corresponding to the yellow light area is a third phosphor layer; wherein the third phosphor layer contains phosphor that converts the excitation beam into yellow light.

13. The lighting system as claimed in claim 12, wherein during a fourth timing sequence, the laser light source module provides the blue laser beam, and the yellow light area of the wavelength converter enters the light transmission path; the blue laser beam passes through the first area of the segmented dichroic mirror and is incident on the yellow light area; wherein the blue laser beam penetrates the anti-reflection layer of the first layer and generates the excitation beam in the third phosphor layer of the second layer; the excitation beam is reflected by the reflective substrate to the segmented dichroic mirror and then transmitted to the light homogenizing component.

14. The lighting system as claimed in claim 13, wherein during the fourth timing sequence, the laser light source module further provides at least one of the green laser beam and the red laser beam, wherein:
when the laser light source module provides the green laser beam in the fourth timing sequence, the green laser beam passes through the first area of the segmented dichroic mirror and is incident on the yellow light area of the wavelength converter; wherein the green laser beam penetrates the anti-reflection layer of the first layer and the third phosphor layer of the second layer, and is reflected by the reflective substrate back to the segmented dichroic mirror, which then reflects the green laser beam to the light homogenizing component;
when the laser light source module provides the red laser beam in the fourth timing sequence, the red laser beam passes through the second area of the segmented dichroic mirror and is incident on the yellow light area of the wavelength converter; wherein the red laser beam penetrates the anti-reflection layer of the first layer and the third phosphor layer of the second layer, and is reflected by the reflective substrate back to the segmented dichroic mirror, which then reflects the red laser beam to the light homogenizing component.

15. The lighting system as claimed in claim 6, further comprising a red light splitter, wherein the red light splitter is located between the first area of the segmented dichroic mirror and the laser light source module; wherein the first area of the segmented dichroic mirror is configured to reflect a first portion of the red laser beam from the wavelength converter and transmit a second portion of the red laser beam; wherein the first portion of the red laser beam is reflected by the first area of the segmented dichroic mirror to the light homogenizing component, the second portion of the red laser beam penetrates the first area of the segmented dichroic mirror and is transmitted to the red light splitter, where the second portion is reflected by the red light splitter and then penetrates the second area of the segmented dichroic mirror to reach the light homogenizing component.

16. The lighting system as claimed in claim 6, further comprising a splitter, wherein the splitter is located between the second area of the segmented dichroic mirror and the wavelength converter; the splitter is configured to reflect a first portion of the blue laser beam from the wavelength converter and transmit a second portion of the blue laser beam; wherein the first portion of the blue laser beam is reflected by the splitter to the light homogenizing component, the second portion of the blue laser beam penetrates the splitter and is transmitted to the second area of the segmented dichroic mirror; wherein the second portion of the blue laser beam is then reflected by the second area of the segmented dichroic mirror to the light homogenizing component.

17. The lighting system as claimed in claim 16, wherein the splitter is further configured to reflect a first portion of the green laser beam from the wavelength converter and transmit a second portion of the green laser beam; wherein the first portion of the green laser beam is reflected by the splitter to the light homogenizing component, the second portion of the green laser beam penetrates the splitter and is transmitted to the second area of the segmented dichroic mirror; wherein the second portion of the green laser beam is then reflected by the second area of the segmented dichroic mirror to the light homogenizing component.

18. The lighting system as claimed in claim 2, further comprising a blue light splitter positioned between the first area of the segmented dichroic mirror and the laser light source module; wherein the laser light source module comprises a multiple of red laser emitters, a multiple of green laser emitters, and a multiple of blue laser emitters, wherein the multiple of green laser emitters and the multiple of blue laser emitters are arranged on different planes; wherein the multiple of red laser emitters are configured to provide the red laser beam, the multiple of blue laser emitters are configured to provide the blue laser beam, and the multiple of green laser emitters are configured to provide the green laser beam; the blue light splitter is positioned in the light transmission path of the blue laser beam and the green laser beam and is configured to reflect the blue laser beam and transmit the green laser beam, thereby directing both the blue laser beam and the green laser beam in the same direction toward the segmented dichroic mirror.

19. The lighting system as claimed in claim 2, further comprising a green light splitter positioned between the first area of the segmented dichroic mirror and the laser light source module; wherein the laser light source module comprises a multiple of red laser emitters, a multiple of green laser emitters, and a multiple of blue laser emitters, wherein the multiple of blue laser emitters and the multiple of green laser emitters are arranged on different planes; wherein the multiple of red laser emitters are configured to provide the red laser beam, the multiple of blue laser emitters are configured to provide the blue laser beam, and the multiple of green laser emitters are configured to provide the green laser beam; wherein the green light splitter is positioned in the light transmission path of the blue laser beam and the green laser beam and is configured to reflect the green laser beam and transmit the blue laser beam, thereby directing both the blue laser beam and the green laser beam in the same direction toward the segmented dichroic mirror.

20. A projection device, comprising:
a lighting system, configured to provide an illumination beam, comprising:
a laser light source module configured to provide a blue laser beam, a green laser beam, and a red laser beam;
a wavelength converter positioned in the transmission paths of the red laser beam, the green laser beam, and the blue laser beam, wherein the wavelength converter is configured to reflect the red laser beam, the green laser beam, and the blue laser beam, and to convert the blue laser beam to produce an excitation beam;
a segmented dichroic mirror positioned in the transmission paths of the red laser beam, the green laser beam, the blue laser beam, and the excitation beam, and located between the laser light source module and the wavelength converter, wherein the segmented dichroic mirror is configured to reflect the red laser beam, the green laser beam, the blue laser beam, and at least a portion of the excitation beam from the wavelength converter; and
a light homogenizing component positioned in the transmission paths of the red laser beam, the green laser beam, the blue laser beam, and at least a portion of the excitation beam, configured to receive and homogenize the red laser beam, the green laser beam, the blue laser beam, and at least a portion of the excitation beam from the segmented dichroic mirror to provide an illumination beam;
a light modulation system positioned in a transmission path of the illumination beam, configured to convert the illumination beam into an image beam; and
a projection lens positioned in a transmission path of the image beam, configured to project the image beam out of the projection device.
